(19) United States
(12) Patent Application Publication
(10) Pub. No.: US 2015/0161543 A1
(43) Pub. Date: Jun. 11, 2015

(54) PREDICTING RENTAL CAR AVAILABILITY

(71) Applicant: NAVIGATION SOLUTIONS, LLC, Plano, TX (US)

(72) Inventors: Yazid Sheik Kadir, Frisco, TX (US); Roger Alan Stevens, Lucas, TX (US); Michael James Mouser, Parker, TX (US)

(21) Appl. No.: 14/525,996

(22) Filed: Oct. 28, 2014

Related U.S. Application Data
(60) Provisional application No. 61/896,148, filed on Oct. 28, 2013.

(51) Int. Cl. G06Q 10/06; H04W 4/04; G06Q 30/06

(52) U.S. Cl. CPC G06Q 10/06314; G06Q 30/0645; H04W 4/046

(57) ABSTRACT

Navigation devices in rental vehicles are used to assist in predicting the probability of when each car will be returned to the car rental company. The probability of each car being returned is based upon is location relative to the return facility, direction of travel, and whether the navigation device is currently routed to the return facility. It is not necessary to predict accurately when a specific car will be returned, although one could implement it that way. Rather, this is primarily a statistical prediction over a large number of vehicles that will inform the car rental company how many vehicles of each type will be returned at a given time.

### BACKGROUND

In order to manage their rental vehicles, a car rental company must be able to estimate how many vehicles or how many vehicles of each type will be available during the day. To some extent, this can be based upon the time and date that other customers have indicated that they will return their rental vehicle. However, there is often wide discrepancy between the time that the customers indicate that they will return the vehicle and the time that they actually return the vehicle. This can make it difficult to prepare each vehicle and assign it to an upcoming reservation prior to the customer's arrival.

### SUMMARY

According to one feature of the system disclosed herein, navigation devices in the rental vehicles are used to assist in predicting the probability of when each car will be returned to the car rental company. It is not necessary to predict accurately when a specific car will be returned, although one could implement it that way. Rather, this is primarily a statistical prediction over a large number of vehicles that will inform the car rental company how many vehicles of each type will be returned at a given time.

### BRIEF DESCRIPTION OF THE DRAWINGS

The drawings can be briefly described as follows:

FIG. 1 schematically illustrates the hardware associated with the rental car system.

FIG. 2 is a map showing one example of an implementation of one feature of the present system.

FIG. 3 shows one example screen of a user's computer showing a dashboard with the information gathered by the system of FIG. 1.

FIG. 4 shows the dashboard of FIG. 3 with an expanded map displayed of the vicinity zone.

FIG. 5 shows the dashboard showing the map of the vicinity zone and the “In Vicinity” metrics displayed.

FIG. 6 shows an enlarged map view on the dashboard of the “on airport zone.”

FIG. 7 shows the “on airport zone” dashboard with metrics.

### DETAILED DESCRIPTION OF A PREFERRED EMBODIMENT

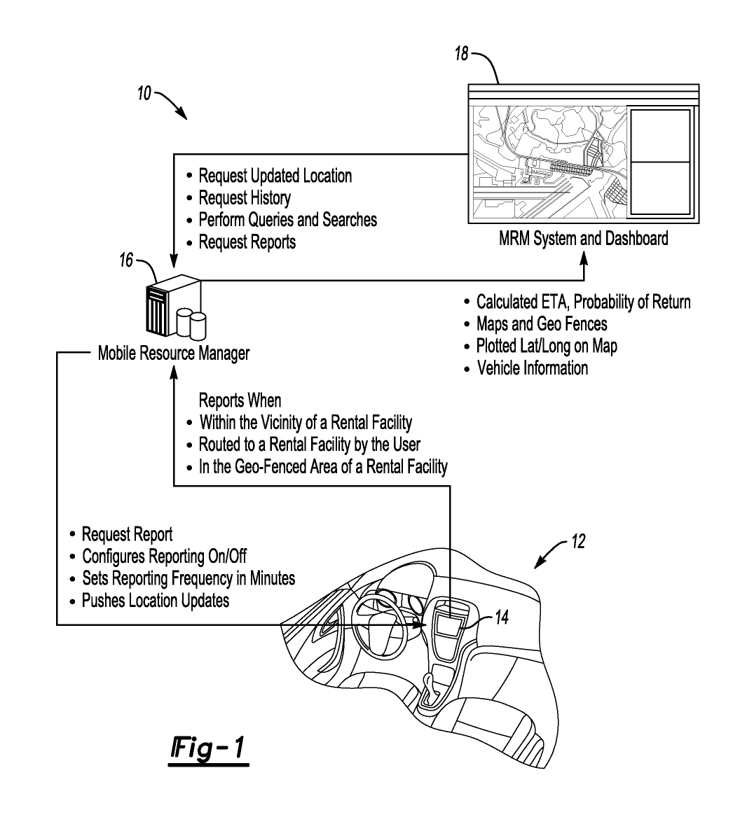

FIG. 1 schematically illustrates the system 10 according to one embodiment. Each vehicle 12 in a rental fleet of vehicles (or, alternatively, a subset of vehicles 12 in a rental fleet) includes a navigation device 14 installed therein and/or associated therewith.

As is known, the navigation device 14 includes at least one computer processor, electronic storage, appropriate software, etc, and position-determining devices or hardware such as a GPS receiver, accelerometers, gyros and/or speed information from the vehicle 12. The navigation device 14 includes or provides access to a database of points of interest, including restaurants, stores, etc and the rental facility to which the vehicle 12 is to be returned, which may be near an airport. The navigation device 14 further includes (or has access to) a database of roads. The navigation device 14 includes a user interface such as a touchscreen and/or voice commands, etc. The navigation device 14 also includes some way of communicating information wirelessly (such as a cell data card, satellite, etc) to a central server, such as a mobile resource manager 16. The navigation device 14 communicates to the mobile resource manager 16, the navigation device's 14 current location, currently-traveled route, speed, direction of travel, and whether the navigation device is being routed to a return facility. Optionally, only a subset of this information is communicated.

The mobile resource server 16 includes computer having at least one processor, electronic storage, appropriate software, communication links, etc. The mobile resource server 16 communicates with the plurality of navigation devices 14 in the fleet of vehicles 12 (e.g. over a network, such as the internet, to the wireless communication on the navigation devices 14). The mobile resource manager 16 also communicates (e.g. over a network, such as the Internet) with a plurality of computers 18 at the local rental facilities. The mobile resource manager 16 collects location information from the navigation devices 14, plots the vehicles 12 on maps, mines their history and performs all Probability and ETA calculations.

The system 10 provides a monitoring system for a fleet of vehicles 12. It predicts the availability of vehicles 12 ready to use by monitoring returning vehicles 12, vehicles 12 on site and vehicles 12 in use. It also tracks vehicles 12 at fleet staging areas and reports those ready for use.

The users of the system 10 (e.g. rental company employees) are presented on computers 18 with estimates of arrival times, distance away and probability of return. The probability of each vehicle's return is a function of the following:

1. Current Location (latitude/longitude)

2. Route the vehicle 12 is traveling on

3. Distance from rental facility

4. Direction of travel

5. Vehicle operator selection to route to rental facility

The system uses GPS devices, Maps, Geo-fences, Dashboards and Reports to inform the users of vehicle location, and availability.

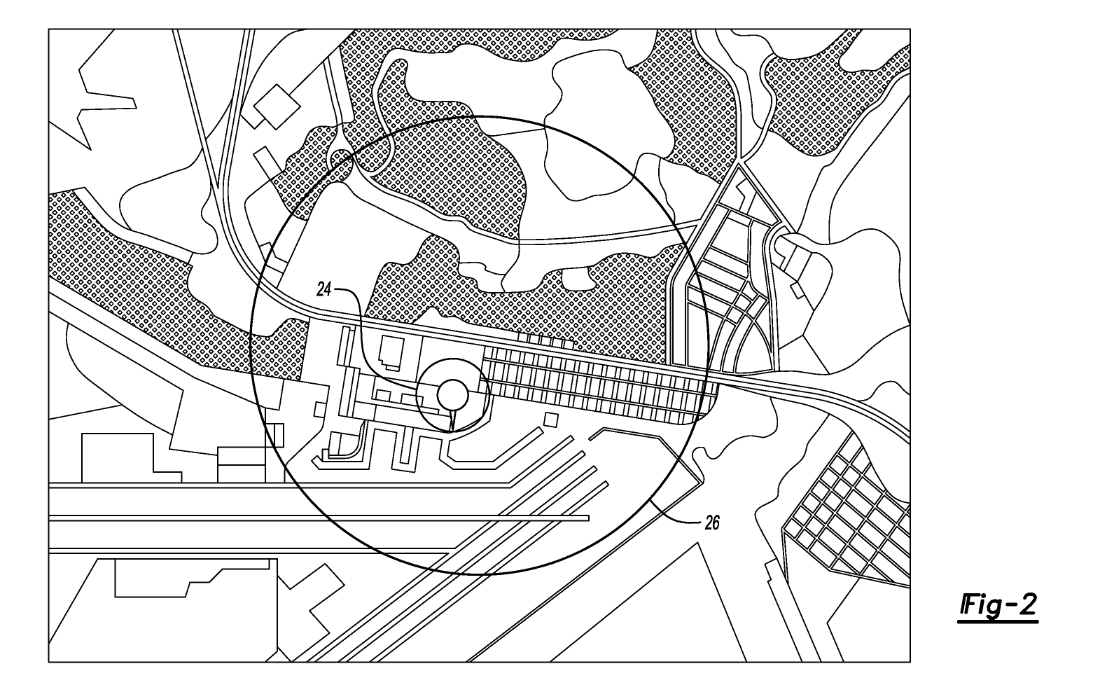

One example of an implementation according to one feature of the present system is illustrated with respect to the map of FIG. 2. A return location or rental facility 24 is shown on the map. A vicinity zone 26 is shown in this example as an area around, but not necessarily centered on, the return location 24. The vicinity zone 26 is not necessarily circular and different shapes may be used for each rental facility 24. The vicinity zone 26 shape may depend on the configuration of roads in the area.

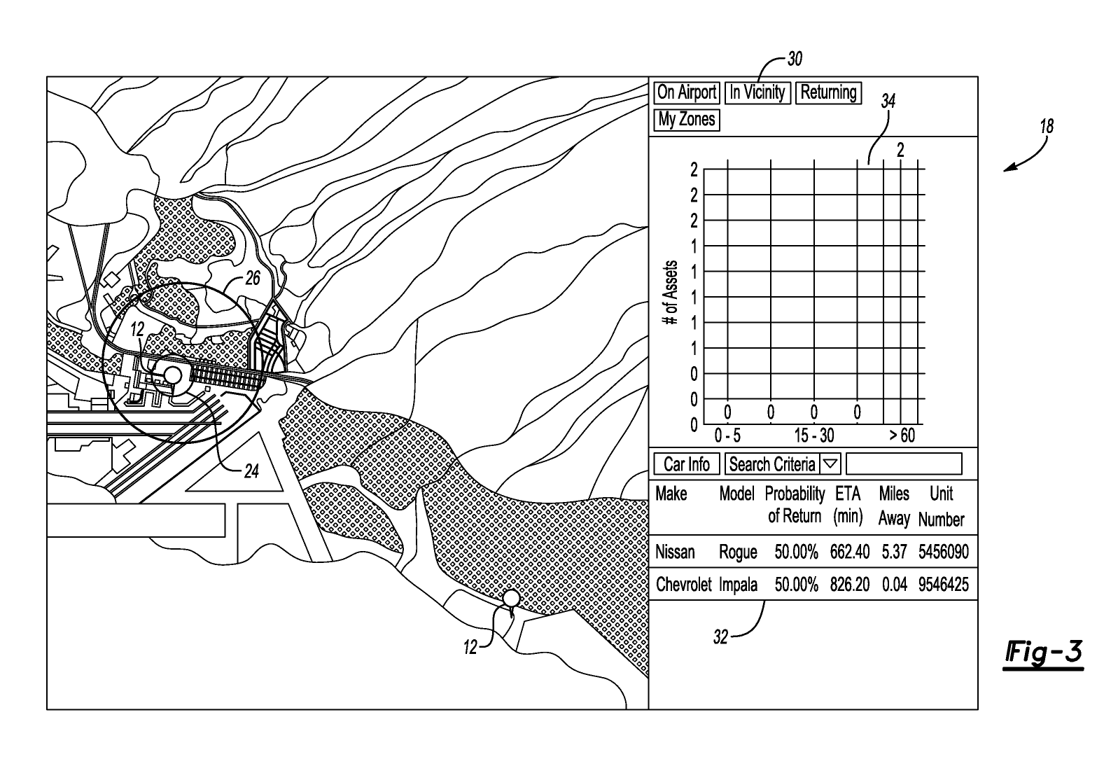

FIG. 3 shows one example of a screen of a user's computer 18 showing a dashboard with the information gathered by the system 10. A map displays the relative locations of the vehicles 12, rental facility 24, and the vicinity zone 26. The dashboard also displays a plurality of buttons 30 permitting the user to choose to see how many vehicles are: on airport, in vicinity, returning or in my zones (customized zones). For example, in FIG. 3, “Returning” is selected and a list 32 identifies two specific vehicles that have been determined to be likely (e.g. 50% or more likely to return), the probability of their return, distance from the rental facility 24. A graph 34 displays the number of vehicles 12 that are likely to be available at future times.

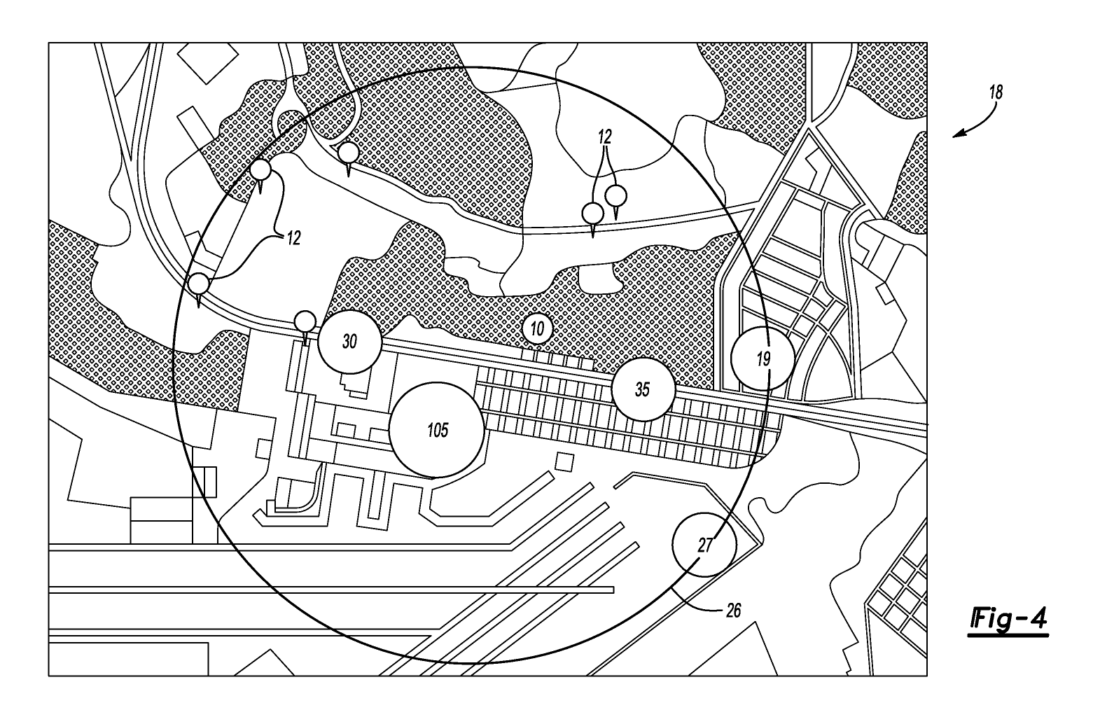

FIG. 4 shows the dashboard of FIG. 3 with an expanded map displayed of the vicinity zone 26. A number of vehicles within a certain radius of one another (depending on zoom level) will simply be indicated as a total number within a circle representing the radius. Users can zoom into the map, which may eventually cause the individual vehicles 12 to be displayed separately (if there is room to display them on the map, depending on map zoom level, the number of vehicles 12 and how close they are to each other). In FIG. 4, several circles are shown with “30,” “10,” “105,” “35,” “19” and “27” vehicles, for example.

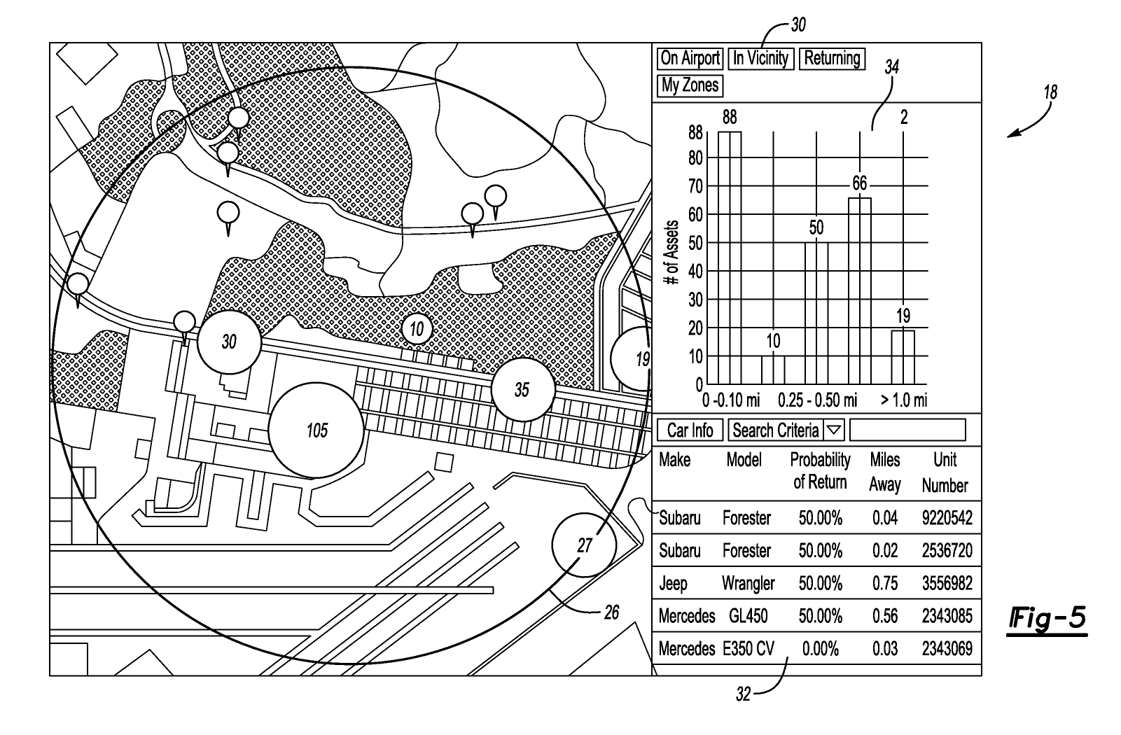

FIG. 5 shows the dashboard showing the map of the vicinity zone 26 and the “In Vicinity” metrics displayed. The graph 34 displays how many vehicles are within certain radii of the rental facility 24. The list 32 identifies a plurality of specific vehicles, their probability of return (as calculated by one of the methods below) and the distance from the rental facility.

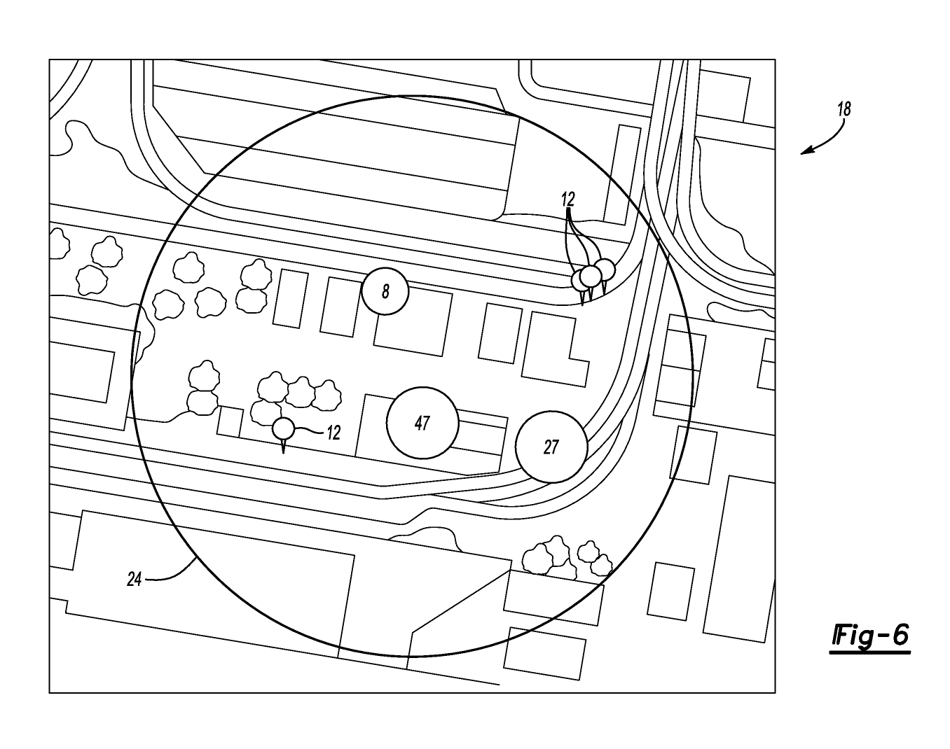

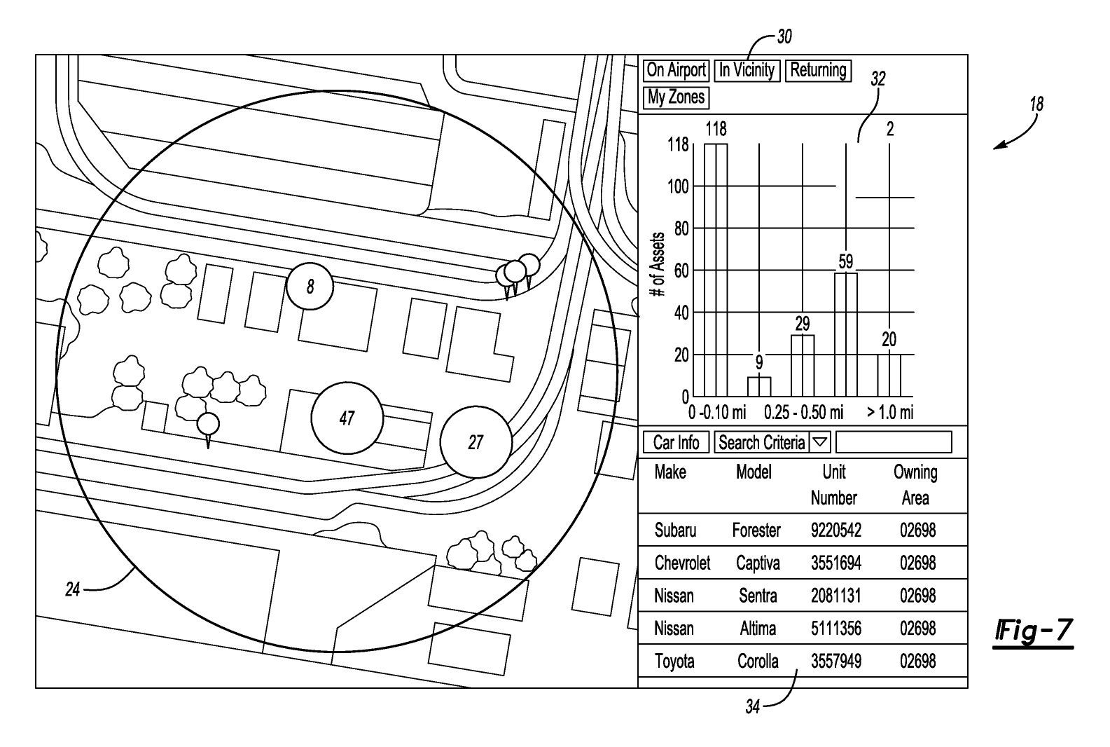

FIG. 6 shows an enlarged map view on the dashboard of the “on airport zone” i.e. at the rental facility 24. The location of the vehicles 12 at the rental facility 24 is shown. FIG. 7 shows the same “on airport zone” with metrics, i.e. the graph 32 and list 34.

One method for predicting rental car availability is described below. Two cases are considered. In the first, there is currently no route plotted by the navigation device 14. In the second, the user has requested a route to the return location 24 from the navigation device 14.

1. Return Algorithm for Vehicle with no Route Plotted:

These checks are run every time a vehicle navigation device 14 reports its current lat/long

On Enter Vicinity Zone:

Check if vehicle has active route to Airport

If no Active Airport Route

Calculate the crowsFly distance from vehicle 12 to Airport Return Location 24

Save crowsFly distance and timestamp

Set Return Probability to 50%

If vehicle is routed to Airport Return Location

Set Return Probability to 70%

Continuous Travel in Vicinity Zone:

The idea here is a traveling vehicle will be in the “On Airport” zone eventually if it is returning. If it's passing through the vicinity of the Airport, eventually its distance to the return location will increase then it will leave the zone all together

Calculate crows fly distance to Airport

If distance decreases increment Return Probability by 5% with a max of 80%

If distance increases decrease Return Probability by 5% with a max of 50%

On Exit in Vicinity Zone:

Reset the Return Probability to 0%

Ignition Off in Vicinity Zone:

Set the Return Probability to 30%

Ignition On in Vicinity Zone:

Reset the Return Probability to last known value

Enters the ‘On Airport’ zone:

Set Return Probability to 80%

Recalculate the crowsFly distance to Return Zone, increase by increments of 2% to a max of 95%

Leaves ‘On Airport’ zone:

Reset Return Probability to last known Vicinity Zone value

At Airport Return Location:

Vehicle is not returned until renter exits

Set Return Probability to 95%

At Airport Return Location and Ignition Off:

The vehicle is returned when the ignition is turned off. It's possible that the ignition is never turned off by the renter as the Rental Car Company takes possession of the vehicle, in which case its ignition is turned off when it's parked in the “returned” lot.

Set Return Probability to 100%

2. Return Algorithm route to Airport Return Location:

In this case the user has routed their vehicle to an Airport Return Location

When a vehicle has a route to the Airport Return Location

Set the Return Probability to 60%

On Enter Vicinity Zone:

When the vehicle enters the Vicinity Zone around the Airport

Set Return Probability to 70%

Continuous Travel in Vicinity Zone:

If distance decreases increment Return Probability by 5% with a max of 80%

If distance increases decrease Return Probability by 5% with a max of 60%

On Exit Vicinity Zone:

They will re-enter or re-plot another route

Reset the Return Probability to 0%

Ignition off in Vicinity Zone:

Reset the Return Probability to 30%

Ignition On in Vicinity Zone:

Reset the Return Probability to last known value

Enters the ‘On Airport’ zone:

Set Return Probability to 90%

Leaves ‘On Airport’ zone:

Reset Return Probability to last known Vicinity Zone value

At Airport Return Location:

Vehicle is not returned until renter exits

Set Return Probability to 95%

At Airport Return Location and Ignition Off:

The vehicle is returned when the ignition is turned off. It's possible that the ignition is never turned off by the renter however as the Rental Car Company takes possession of the vehicle, its ignition is turned off when it's parked in the “returned” lot.

Set Return Probability to 100%

Thus, generally speaking, the return probability for each vehicle 12 is determined based upon the current location of the vehicle 12. The return probability may be based upon a comparison of the location to the location of the rental facility (or return facility). The return probability may be based upon a comparison of the location to one or more zones (which may be a simple radius or a more complex shape). The probability may also be based on the current direction of travel (e.g. is the vehicle 12 travelling toward the rental facility 24). The probability may be in terms of percent likelihood that the vehicle 12 will be returned within a certain period of time (e.g. 30 minutes). An estimated time of arrival of the vehicle 12 at the rental facility 24 may also be calculated.

An alternate method of calculating the probability of vehicle return is described below.

Probability of a vehicle returning when it enters a Vicinity Zone

$$A = Car is being returned$$

$$B = Car is passing through the zone$$

$$C = Car returns to rental facility , but rental is not over ( dropping a friend off for example ) . \begin{matrix}P ( A or B or C ) = P ( A or B or C ) \\ = P ( ( A or B ) or C ) \\ = ( ( a + b ) - ( a * b ) + c ) - ( ( ( a + b ) - ( a * b ) ) * c ) \\ = ( a + b + c - ab ) - ( ac + bc - abc ) \\ = a + b + c - ab - ac - bc + abc\end{matrix}$$

If multiple zones are used for a rental facility, the probability increases as the vehicle passes through more zones. In this case the probability of A occurring will increase by a fraction for each zone.

P(A) then becomes P(A+1/6) for each zone crossed

The probability of a vehicle stopped/parked in a Zone returning is:

$$D = Car is stopped at location in zone$$

$$Da = Car is visiting that location , not returning$$

$$Db = Car is getting gas , will return eventually$$

$$\begin{matrix}P ( A or B ) = P ( A ) + P ( B ) - P ( A and B ) \\ = P ( Da or Db )\end{matrix}$$

Based upon the calculated probability, the user can determine whether to take a reservation for a particular vehicle type or to assign a type of vehicle to a customer or to make other planning decisions based upon the number and types of vehicles that can be expected to be returned. Alternatively, the probability of return can be input into the reservation system, so that a reservation server computer can automatically determine what vehicles to make available for reservations based upon the probability of vehicles being returned. In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, the location of the vehicles 12 could be provided with location determining devices that are not part of a navigation system.

What is claimed is:

1. A method for determining the likelihood of a rented vehicle being returned to a return facility including the steps of:
a) determining a current location of the rented vehicle;
b) comparing the current location of the rented vehicle to a location of the return facility;
c) calculating a probability that the rented vehicle will be returned based upon said step b).

2. The method of claim 1 further including the step of: d) determining whether a navigation device in the rented vehicle is currently routing to the return facility, wherein said step c) is performed based upon said step d).

3. The method of claim 1 further including the step of d) determining a direction of travel of the rented vehicle, wherein step c) is performed based upon said step d).

4. The method of claim 1 wherein the rented vehicle is one of a plurality of rented vehicles and wherein said steps a-c) are performed for each of the plurality of rented vehicles concurrently.

5. The method of claim 1 further including the step of altering the calculated probability that the rented vehicle will be returned based upon whether the vehicle is running.

6. The method of claim 1 further including the step of altering the calculated probability that the rented vehicle will be returned based upon a determination that the vehicle is within a first radius of the return facility.

7. The method of claim 7 further including the step of increasing the calculated probability that the rented vehicle will be returned based upon a determination that the vehicle is within a second radius of the return facility, the second radius smaller than the first radius.

8. A vehicle rental system comprising:
a plurality of vehicles;
each vehicle having a location-determining device associated therewith; and
a computer receiving current location information from each of the location-determining devices and determining a probability that each vehicle will be returned based upon the current location received from the associated location-determining devices.

9. The vehicle rental system of claim 8 wherein each location-determining device is part of a navigation device.

10. The vehicle rental system of claim 8 wherein the computer determines a probability that each vehicle will be returned based upon a comparison of the current location of each vehicle to a location of a return facility.

11. The vehicle rental system of claim 8 wherein the computer determines a probability that each vehicle will be returned based upon a direction of travel of the vehicle.
